(19) United States
(12) Patent Application Publication
(10) Pub. No.: US 2026/0285425 A1
(43) Pub. Date: Sep. 24, 2026

(54) TRAVELING DEVICE FOR TRACKED VEHICLE AND TRACKED VEHICLE

(71) Applicant: KOMATSU LTD., Tokyo (JP)

(72) Inventor: Masahiro Koike, Tokyo (JP)

(73) Assignee: KOMATSU LTD., Tokyo (JP)

(21) Appl. No.: 19/476,723

(22) PCT Filed: Apr. 26, 2024
(86) PCT No.: PCT/JP2024/016596

§ 371 Date: Oct. 20, 2025

(30) Foreign Application Priority Data
Apr. 26, 2023 (JP) 2023-072021

(51) Int. Cl. B62D 55/104; B62D 55/06; B62D 55/10; B62D 55/14; E02F 3/76; E02F 9/02

(52) U.S. Cl. CPC B62D 55/104; B62D 55/06; B62D 55/10; B62D 55/14; E02F 9/02; E02F 3/7609

(57) ABSTRACT

A traveling device (5) includes: a truck frame (30); a first arm member (70) attached to the truck frame such that a front end portion and a rear end portion are alternately swingable up and down; a first track roller (41) attached to the front end portion of the first arm member; a rear end idler (80) attached to the rear end portion of the first arm member; a plurality of traveling wheels (40 and 42 to 48) provided at the truck frame; and a crawler belt (50) wound around the first track roller, the rear end idler, and the plurality of traveling wheels, in which a distance (Lr) between a swing center (Cm) of the first arm member and a rotation center (Cr) of the rear end idler is longer than a distance (Lf) between the swing center of the first arm member and a rotation center (Cf) of the first track roller in a side view.

### TECHNICAL FIELD

The present disclosure relates to a traveling device for a tracked vehicle and a tracked vehicle.

The present application claims priority based on Japanese Patent Application No. 2023-072021 filed in Japan on Apr. 26, 2023, the contents of which are incorporated herein by reference.

### BACKGROUND ART

There is a tracked vehicle having a structure for causing a track roller to follow a change in an up and down direction of a crawler belt caused by rough ground at the time of traveling. Patent Literature 1 discloses a structure including a truck frame, a first arm member attached to the truck frame, and a first elastic abutting portion and a second elastic abutting portion provided between the first arm member and the truck frame and capable of elastically abutting on each other. A support axis of an elastic support portion is inclined in the front and rear direction. A perpendicular line of an abutting surface of the first elastic abutting portion and the second elastic abutting portion is inclined in the same direction as that of the support axis of the elastic support portion in the front and rear direction.

### CITATION LIST

### Patent Literature

Patent Literature 1: JP 2007-1377 A

### SUMMARY OF INVENTION

### Technical Problem

However, the tracked vehicle often travels on rough uneven ground, and when the tracked vehicle goes over an obstacle and falls from the obstacle, the tracked vehicle receives a large impact. For example, when the vehicle goes over a large chunk at the time of traveling backward on a bad road, a thrust-up force is generated in the forward and upward direction in a part of the first arm member. In this case, there is a possibility that the impact cannot be sufficiently absorbed depending on the configuration of the first arm member. Therefore, there is room for improvement in reducing the impact at the time of traveling backward on a bad road.

In view of this, an object of the present disclosure is to provide a traveling device for a tracked vehicle and a tracked vehicle, each of which is capable of reducing an impact at the time of traveling backward on a bad road.

### Solution to Problem

A traveling device for a tracked vehicle according to one aspect of the present disclosure includes: a truck frame arranged on a side portion of a vehicle body frame; a first arm member attached to the truck frame such that a front end portion and a rear end portion are alternately swingable up and down; a first track roller rotatably attached to the front end portion of the first arm member; a rear end idler rotatably attached to the rear end portion of the first arm member; a plurality of traveling wheels provided at a front portion and a rear portion of the truck frame; and a crawler belt wound around the first track roller, the rear end idler, and the plurality of traveling wheels, in which a rear-side center-to-center distance between a swing center of the first arm member and a rotation center of the rear end idler is longer than a front-side center-to-center distance between the swing center of the first arm member and a rotation center of the first track roller in a side view.

### Advantageous Effects of Invention

According to the above aspect, it is possible to reduce an impact at the time of traveling backward on a bad road.

### BRIEF DESCRIPTION OF DRAWINGS

FIG. 1 is a side view of a tracked vehicle according to an embodiment.

FIG. 2 is a side view of a traveling device according to an embodiment.

FIG. 3 is a side view of a structure including a first arm member according to an embodiment.

FIG. 4 is an explanatory view of a function of a structure according to an embodiment.

FIG. 5 illustrates a structure according to a comparative example.

### DESCRIPTION OF EMBODIMENTS

Hereinafter, embodiments of the present disclosure will be described with reference to the drawings. In the embodiments, a construction vehicle such as a bulldozer that performs work on uneven ground will be described as a tracked vehicle.

In the following description, for example, expressions indicating relative or absolute arrangements such as “parallel”, “orthogonal”, “center”, and “coaxial” not only strictly mean such arrangements and states, but also include arrangements and states that are relatively displaced with tolerances or with an angle or distance at which the same function can be obtained.

### Tracked Vehicle

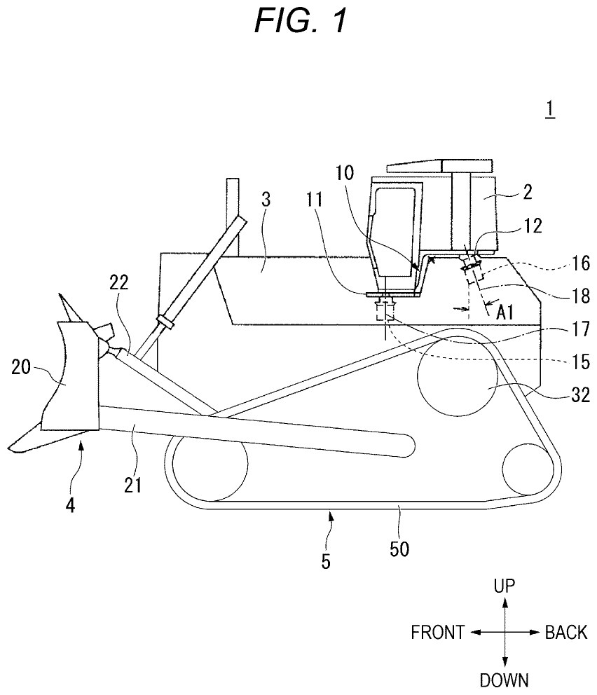

FIG. 1 is a side view of a tracked vehicle 1 according to an embodiment.

As illustrated in FIG. 1, the tracked vehicle 1 includes a cab 2, a vehicle body frame 3 on which the cab 2 is placed, a work mechanism 4, and a pair of traveling devices 5.

Hereinafter, a forward direction (front side of the vehicle body), a backward direction (rear side of the vehicle body), and a vehicle width direction (left and right direction of the vehicle body) of the tracked vehicle 1 will be referred to as “vehicle front side (one side in the vehicle front and rear direction)”, “vehicle rear side (the other side in the vehicle front and rear direction)”, and “vehicle width direction”. The vehicle width direction may also be referred to as “left side (one side in the vehicle width direction)” or “right side (the other side in the vehicle width direction)”. A right-hand side in a direction in which the tracked vehicle 1 moves forward will be referred to as a right side, and a left-hand side in the direction in which the tracked vehicle 1 moves forward will be referred to as a left side. A vehicle up and down direction (vehicle body up and down direction), above the vehicle (above the vehicle body), and below the vehicle (below the vehicle body) of the tracked vehicle 1 will be simply referred to as “up and down direction”, “above”, and “below”. In the example of the drawing, the tracked vehicle 1 is arranged on a horizontal plane (horizontal ground). The vehicle up and down direction (vehicle body up and down direction), above the vehicle (above the vehicle body), and below the vehicle (below the vehicle body) of the tracked vehicle 1 coincide with the up and down direction (vertical direction), vertically above, and vertically below, respectively, in a state in which the tracked vehicle 1 is arranged on the horizontal plane. The “side view” refers to a view seen in the left and right direction.

### Cab

For example, the cab 2 houses a seat for a driver of the tracked vehicle 1 to sit, levers, pedals, and instruments for various operations. The bottom of the cab 2 is constituted by a floor frame 10. Pillars and side plates are placed on the floor frame 10. The floor frame 10 has a shape in which a step is provided at an intermediate portion in the front and rear direction such that its front portion is low and its rear portion is high. The floor frame 10 includes a low floor portion 11 on the front side and a high floor portion 12 on the rear side.

### Vehicle Body Frame

The work mechanism 4 and the traveling device 5 are attached to the vehicle body frame 3. The cab 2 is placed in an upper portion on the rear side of the vehicle body frame 3. A main frame (not illustrated) is provided in a lower portion of the vehicle body frame 3. Although not illustrated, the vehicle body frame 3 is provided with an engine, a torque converter, a transmission, and the like. Driving force generated by the engine is transmitted to a sprocket 32 of the traveling device 5.

The vehicle body frame 3 is not limited to being provided with an engine or the like as a power source. For example, the vehicle body frame 3 may be provided with an electric motor or the like as a power source. For example, the traveling device 5 may travel by transmitting power of an internal combustion engine, an electric motor, or the like serving as a power source to a crawler belt 50. For example, the mode of the power source can be changed in accordance with the design specifications.

Elastic support portions 15 and 16 that elastically support the cab 2 from below are provided between the cab 2 and the vehicle body frame 3. For example, the elastic support portions 15 and 16 are liquid-sealed rubber mount devices in which a damping liquid is sealed inside a case and a support shaft protrudes from a central portion of an upper surface of the case. The support shaft is fixed to the cab 2. The case is fixed to the vehicle body frame 3.

The elastic support portions 15 and 16 are a pair of front elastic support portions 15 that supports a front portion of the cab 2 and a pair of rear elastic support portions 16 that supports a rear portion of the cab 2.

The front elastic support portions 15 are fixed to left and right side end portions of a lower surface of the low floor portion 11 of the floor frame 10 with bolts or the like via brackets. In the example of the drawing, the front elastic support portions 15 are fixed to the lower surface of the low floor portion 11 such that an axial center 17 (hereinafter, also referred to as “front-side support axis 17”) of the support shaft extends along the vertical direction. The direction along which the front-side support axis 17 extends is not limited to the above and can be changed in accordance with the design specifications.

The rear elastic support portions 16 are fixed to left and right side end portions of a lower surface of the high floor portion 12 of the floor frame 10 with bolts or the like via brackets. In the example of the drawing, the rear elastic support portions 16 are fixed to the lower surface of the high floor portion 12 such that an axial center 18 (hereinafter, also referred to as “rear-side support axis 18”) of the support shaft is inclined forward with respect to the vertical direction. In the example of the drawing, an angle of inclination A1 of the rear-side support axis 18 with respect to the vertical direction is about 15 degrees. The direction along which the rear-side support axis 18 extends (angle of inclination A1) is not limited to the above and can be changed in accordance with the design specifications.

### Work Mechanism

The work mechanism 4 is a mechanism for scraping the ground and pushing and carrying earth and sand. The work mechanism 4 includes a blade 20 and support frames 21 and 22 that support the blade 20. The blade 20 is provided in front of the vehicle body frame 3. The blade 20 has a plate shape with a curved front surface. One ends of the support frames 21 and 22 are fixed to the blade 20. The other ends of the support frames 21 and 22 are fixed to the vehicle body frame 3 or the traveling device 5.

### Traveling Device

The traveling device 5 is provided at each of left and right lower portions of the vehicle body frame 3. The pair of traveling devices 5 is provided on the left and right outer sides of the main frame (not illustrated). The traveling device 5 can travel on uneven ground with the endless crawler belt 50. Hereinafter, one of the pair of traveling devices 5 will be described. The other traveling device 5 has a similar structure to the one traveling device 5, and thus the detailed description thereof will be omitted.

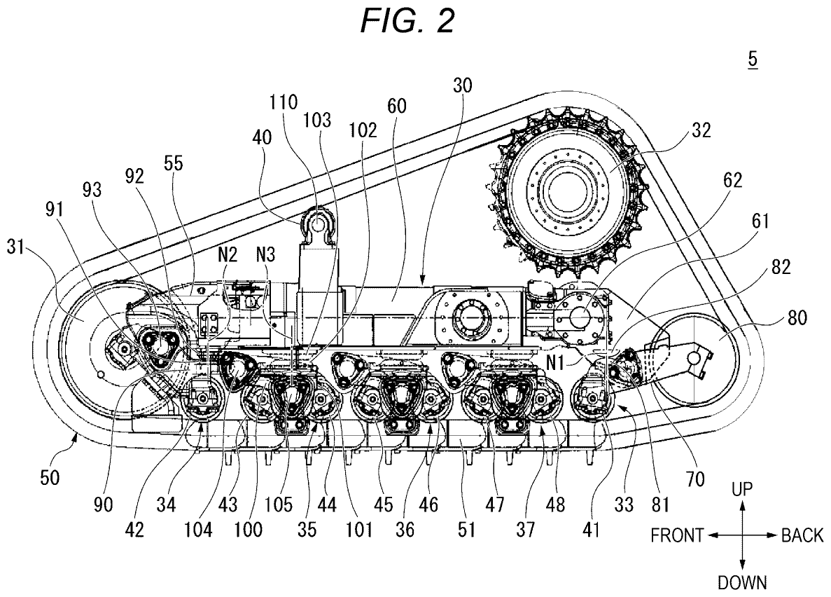

When referring to FIGS. 1 and 2, the traveling device 5 includes a truck frame 30 arranged on a side portion of the vehicle body frame 3, an idler 31 and the sprocket 32 which are traveling wheels, a first single bogie device 33, a second single bogie device 34, and a plurality of double bogie devices 35, 36, and 37 having track rollers 41 to 48 rotatably and swingably supported on a lower portion of the truck frame 30, a carrier roller 40, and the crawler belt 50. The single bogie device is a bogie device having one swing arm. The double bogie device is a bogie device having two swing arms.

### Truck Frame

The truck frame 30 is provided along the vehicle front and rear direction. The truck frame 30 is arranged on a lower side surface of the vehicle body frame 3. A yoke 55 biased forward via a spring (an example of a biasing member) (not illustrated) is attached to a front end portion of the truck frame 30 so as to be movable in the front and rear direction. The idler 31 is rotatably attached to a front end portion of the second single bogie device 34. The sprocket 32 is arranged near a rear end portion of the truck frame 30. The sprocket 32 is rotatably attached to a rear portion of the vehicle body frame 3. The sprocket 32 is rotated by transmission of the driving force from the engine.

The truck frame 30 includes a frame body 60 provided along the vehicle front and rear direction and a rear end frame 61 attached to a rear portion of the frame body 60. The rear end frame 61 has a portion for attaching a first arm member 70 described later. A front upper portion of the rear end frame 61 is fixed to a rear end portion of the frame body 60. The left and right truck frames 30 are attached to left and right center main frames (not illustrated) via a pivot shaft 62. For example, the frame body 60 and the rear end frame 61 may be the same component. In other words, the frame body 60 and the rear end frame 61 may be integrally formed. For example, the rear end frame 61 may be the rear end portion of the frame body 60.

### First Single Bogie Device

When referring also to FIGS. 1 to 3, the first single bogie device 33 is provided at a rear-side lower portion of the truck frame 30 close to the sprocket 32. The first single bogie device 33 includes the first arm member 70, the first track roller 41, a rear end idler 80, and elastic abutting portions 81 and 82.

The first arm member 70 is attached to the truck frame 30 such that a front end portion and a rear end portion thereof are alternately swingable up and down. In other words, the first arm member 70 is attached to the truck frame 30 so as to be rotatable about an axis extending in a direction intersecting the up and down direction at an intermediate portion between the front end portion and the rear end portion. The first arm member 70 has a shaft support portion rotatably fixed to the truck frame 30 by a pin 71 (hereinafter, also referred to as “center-side pin 71”) near the center in the front and rear direction of the first arm member 70. The first arm member 70 extends diagonally downward and forward from the shaft support portion to the front end portion and extends diagonally upward and backward from the shaft support portion to the rear end portion. When the first arm member 70 rotates about the center-side pin 71, the front end portion and the rear end portion of the first arm member 70 are swingable about the shaft support portion with respect to the truck frame 30. The center-side pin 71 is arranged such that a center axis thereof extends in a direction intersecting the up and down direction.

The first track roller 41 is rotatably attached to the front end portion of the first arm member 70. The first track roller 41 is rotatably attached to the front end portion of the first arm member 70 by a pin 72 (hereinafter, also referred to as “front-end-side pin 72”). The first track roller 41 is swingable up and down by the front end portion of the first arm member 70 swinging up and down. The first track roller 41 moves up and down by following operation of the crawler belt 50. A center axis of the front-end-side pin 72 and the center axis of the center-side pin 71 are parallel to each other.

The rear end idler 80 is rotatably attached to the rear end portion of the first arm member 70. The rear end idler 80 is rotatably attached to the rear end portion of the first arm member 70 by a pin 73 (hereinafter, also referred to as “rear-end-side pin 73”). The rear end idler 80 corresponds to an idler provided on the rear end side of the truck frame 30 (the side opposite to the idler 31 on the front side in the front and rear direction). The rear end idler 80 is arranged behind the first track roller 41, the second track roller 42, and a plurality of the other track rollers 43 to 48. The rear end idler 80 is arranged behind the plurality of traveling wheels 40 to 48. The rear end idler 80 is also arranged behind the sprocket 32. The rear end idler 80 is swingable up and down by the rear end portion of the first arm member 70 swinging up and down. The rear end idler 80 moves up and down by following operation of the crawler belt 50. A center axis of the rear-end-side pin 73 and the center axis of the center-side pin 71 are parallel to each other.

In a side view, a rear-side center-to-center distance Lr between a swing center Cm of the first arm member 70 and a rotation center Cr of the rear end idler 80 is longer than a front-side center-to-center distance Lf between the swing center Cm of the first arm member 70 and a rotation center Cf of the first track roller 41. The rear-side center-to-center distance Lr corresponds to the length of a line segment connecting a rotation center of the center-side pin 71 and a rotation center of the rear-end-side pin 73. The front-side center-to-center distance Lf corresponds to the length of a line segment connecting the rotation center of the center-side pin 71 and a rotation center of the front-end-side pin 72.

In the present embodiment, the rear-side center-to-center distance Lr is 1.5 times or more and 2.5 times or less the front-side center-to-center distance Lf. In the example of the drawing, the rear-side center-to-center distance Lr is about twice the front-side center-to-center distance Lf.

In the present embodiment, in a normal state in which the traveling device 5 stands still on flat ground, the rotation center Cr of the rear end idler 80 is arranged above the swing center Cm of the first arm member 70. In a side view, the rotation center Cr of the rear end idler 80 is at a position rotated counterclockwise about the swing center Cm by an angle Ar of 10 degrees or more and 20 degrees or less with respect to an imaginary horizontal line Hm passing through the swing center Cm of the first arm member 70. The angle Ar corresponds to the smallest angle among angles formed by the imaginary horizontal line Hm passing through the rotation center of the center-side pin 71 and the line segment connecting the rotation center of the center-side pin 71 and the rotation center of the rear-end-side pin 73 in a side view. In the example of the drawing, the angle Ar is about 15 degrees.

The elastic abutting portions 81 and 82 are pads made from an elastic material provided in the truck frame 30 and the first arm member 70, respectively, between the first arm member 70 and the truck frame 30 in a swinging direction of the front end portion of the first arm member 70. For example, the elastic abutting portions 81 and 82 are made from an elastic material such as natural rubber (an example of rubber). The elastic abutting portions 81 and 82 elastically abut on each other by the first arm member 70 moving in a direction approaching the truck frame 30 (for example, rotating clockwise about the center-side pin 71). Hereinafter, of the pair of elastic abutting portions 81 and 82, the elastic abutting portion 81 provided on the first arm member 70 side will also be referred to as “first elastic abutting portion 81”, and the elastic abutting portion 82 provided on the truck frame 30 side will also be referred to as “second elastic abutting portion 82”.

The first elastic abutting portion 81 is provided at the front upper portion of the first arm member 70. The first elastic abutting portion 81 is arranged diagonally above and ahead of the center-side pin 71. For example, the first elastic abutting portion 81 may be fixed to the front upper portion of the first arm member 70 with a bolt or the like via a first bracket (not illustrated). For example, the first elastic abutting portion 81 may have a shape curved upward from an upper surface of the first bracket along the horizontal plane in a side view. In other words, the first elastic abutting portion 81 may have a convex shape curved upward from the upper surface of the first bracket in a side view.

The second elastic abutting portion 82 is provided at a lower portion of the truck frame 30. For example, the second elastic abutting portion 82 may be fixed to a lower portion of the rear end frame 61 constituting the truck frame 30 with a bolt or the like via a second bracket (not illustrated). For example, the second elastic abutting portion 82 may have a shape curved downward from a lower surface of the second bracket along the horizontal plane in a side view. In other words, the second elastic abutting portion 82 may have a shape curved downward from the lower surface of the second bracket in a side view.

In the example of the drawing, an abutting surface on which the first elastic abutting portion 81 and the second elastic abutting portion 82 abut is arranged diagonally forward and upward from the center-side pin 71. A perpendicular line N1 of the abutting surface is arranged in front of the center-side pin 71 and behind the front-end-side pin 72. The perpendicular line N1 of the abutting surface is substantially parallel to the vertical direction. The perpendicular line N1 of the abutting surface corresponds to a normal line of the curved surface of each of the elastic abutting portions 81 and 82 at a first contact point when the elastic abutting portions 81 and 82 abut on each other. The perpendicular line N1 of the abutting surface may be inclined forward by a predetermined angle with respect to the vertical direction. For example, a direction along the perpendicular line N1 of the abutting surface (angle of inclination) is not limited to the above and can be changed in accordance with the design specifications.

In the normal state in which the traveling device 5 stands still on flat ground, the first elastic abutting portion 81 and the second elastic abutting portion 82 are pressed against each other by the weight of the vehicle body frame 3, the cab 2, and the like and abut on each other. In the normal state, the perpendicular line N1 of the abutting surface of the elastic abutting portions 81 and 82 is substantially parallel to the vertical direction as described above. Rotation of the first arm member 70 (specifically, an upward swing of the front end portion of the first arm member 70) is restricted by abutment between the first elastic abutting portion 81 and the second elastic abutting portion 82. Due to the abutment between the first elastic abutting portion 81 and the second elastic abutting portion 82, a load applied to the first track roller 41 is received, and an impact received by the first track roller 41 is absorbed.

### Second Single Bogie Device

When referring to FIG. 2, the second single bogie device 34 is provided at a front lower portion of the truck frame 30 close to the idler 31 and is rotatably attached to the yoke 55 by a pin 93. The second single bogie device 34 includes the idler 31, a second arm member 90, the second track roller 42, and elastic abutting portions 91 and 92.

The second arm member 90 is attached to a lower portion of the yoke 55 such that a distal end portion thereof is swingable up and down. The second arm member 90 has a proximal end portion rotatably fixed to the yoke 55 by the pin 93. The second arm member 90 has a shape extending diagonally downward and backward from the proximal end portion to the distal end portion. When the second arm member 90 rotates about the pin 93, the distal end portion of the second arm member 90 is swingable about the proximal end portion with respect to the yoke 55.

The second track roller 42 is rotatably attached to a rear end portion of the second arm member 90. The second track roller 42 is arranged closest to the idler 31 (that is, on the foremost side) among the first track roller 41, the second track roller 42, and the plurality of the other track rollers 43 to 48. The second track roller 42 is arranged diagonally below and behind the idler 31 in a side view. The second track roller 42 is swingable up and down by the distal end portion of the second arm member 90 swinging up and down. The second track roller 42 moves up and down by following operation of the crawler belt 50.

The elastic abutting portions 91 and 92 are pads made from an elastic material provided in the truck frame 30 and the second arm member 90, respectively, between the second arm member 90 and the truck frame 30 in a swinging direction of the distal end portion of the second arm member 90. For example, the elastic abutting portions 91 and 92 are made from an elastic material such as natural rubber (an example of rubber). Hereinafter, of the pair of elastic abutting portions 91 and 92, the elastic abutting portion 91 provided on the second arm member 90 side will also be referred to as “third elastic abutting portion 91”, and the elastic abutting portion 92 provided on the truck frame 30 side will also be referred to as “fourth elastic abutting portion 92”.

The third elastic abutting portion 91 is provided on an upper surface of the second arm member 90. The third elastic abutting portion 91 is arranged above the rear end portion of the second arm member 90. For example, the third elastic abutting portion 91 may have a shape parallel to the upper surface of the second arm member 90 along the horizontal plane in a side view.

The fourth elastic abutting portion 92 is provided at the lower portion of the truck frame 30. For example, the fourth elastic abutting portion 92 may be fixed to the lower portion of the truck frame 30 with a bolt or the like via a bracket (not illustrated). For example, the fourth elastic abutting portion 92 may have a shape parallel to a lower surface of the bracket along the horizontal plane in a side view.

For example, an abutting surface on which the third elastic abutting portion 91 and the fourth elastic abutting portion 92 abut is provided in substantially parallel to the horizontal plane. A perpendicular line N2 of the abutting surface is substantially parallel to the vertical direction. The perpendicular line N2 of the abutting surface may be inclined forward by a predetermined angle with respect to the vertical direction. For example, a direction along the perpendicular line N2 of the abutting surface (angle of inclination) is not limited to the above and can be changed in accordance with the design specifications.

In the normal state in which the traveling device 5 stands still on flat ground, the third elastic abutting portion 91 and the fourth elastic abutting portion 92 are pressed against each other by the weight of the vehicle body frame 3, the cab 2, and the like and abut on each other. In the normal state, the abutting surface of the elastic abutting portions 91 and 92 is substantially parallel to the horizontal plane. In the normal state, the perpendicular line N2 of the abutting surface of the elastic abutting portions 91 and 92 is substantially parallel to the vertical direction. Upward rotation of the second arm member 90 is restricted by abutment between the third elastic abutting portion 91 and the fourth elastic abutting portion 92. Due to the abutment between the third elastic abutting portion 91 and the fourth elastic abutting portion 92, a load applied to the second track roller 42 is received, and an impact received by the second track roller 42 is absorbed.

### Double Bogie Device

When referring to FIG. 2, the plurality of double bogie devices 35, 36, and 37 is provided between the first single bogie device 33 and the second single bogie device 34. In the example of the drawing, the three double bogie devices 35, 36, and 37 are arranged side by side in the front and rear direction between the first single bogie device 33 and the second single bogie device 34. The number of double bogie devices 35, 36, and 37 is not limited to the above and can be changed in accordance with the design specifications.

Hereinafter, a structure of one of the double bogie devices 35, 36, and 37 (double bogie device 35) will be described, but the other double bogie devices 36 and 37 have a similar structure.

The double bogie device 35 includes a third arm member 100, a fourth arm member 101, the third track roller 43, the fourth track rollers 44, and elastic abutting portions 102 and 103.

The third arm member 100 is attached to the lower portion of the truck frame 30 such that a distal end portion thereof is swingable up and down. The third arm member 100 has a proximal end portion rotatably fixed to the truck frame 30 by a pin 104. The third arm member 100 has a shape extending diagonally downward and backward from the proximal end portion to the distal end portion. When the third arm member 100 rotates about the proximal end portion of the third arm member 100, the distal end portion of the third arm member 100 is swingable about the proximal end portion with respect to the truck frame 30. The other double bogie devices 36 and 37 also include arm members similar to the third arm member 100, and the arm members are arranged side by side in the front and rear direction.

In the fourth arm member 101, a substantially central portion of the fourth arm member 101 is rotatably attached to the distal end portion of the third arm member 100 by a pin 105. The fourth arm member 101 has a shape extending from the substantially central portion to both end portions in the front and rear direction around the pin 105. When the fourth arm member 101 rotates about the pin 105, both end portions of the fourth arm member 101 are alternately swingable up and down. The other double bogie devices 36 and 37 also include arm members similar to the fourth arm member 101, and the arm members are arranged side by side in the front and rear direction.

The third track roller 43 is rotatably attached to a front end portion of the fourth arm member 101. The fourth track roller 44 is rotatably attached to a rear end portion of the fourth arm member 101. The third track roller 43 and the fourth track roller 44 are arranged symmetrically about the pin 105 in a side view (in other words, symmetrically in the vehicle front and rear direction). The other double bogie devices 36 and 37 also include similar track rollers to the third track roller 43 and the fourth track roller 44, and the track rollers are arranged side by side in the front and rear direction together with the first track roller 41 and the second track roller 42.

The elastic abutting portions 102 and 103 are pads made from an elastic material provided in the truck frame 30 and the third arm member 100, respectively, between the third arm member 100 and the truck frame 30 in a swinging direction of the distal end portion of the third arm member 100. For example, the elastic abutting portions 102 and 103 are made from an elastic material such as natural rubber (an example of rubber). Hereinafter, of the pair of elastic abutting portions 102 and 103, the elastic abutting portion 102 provided on the third arm member 100 side will also be referred to as “fifth elastic abutting portion 102”, and the elastic abutting portion 103 provided on the truck frame 30 side will also be referred to as “sixth elastic abutting portion 103”.

The fifth elastic abutting portion 102 is provided on an upper surface of the third arm member 100. The fifth elastic abutting portion 102 is arranged above the pin 105 at the distal end portion of the third arm member 100. For example, the fifth elastic abutting portion 102 may have a shape parallel to the upper surface of the third arm member 100 along the horizontal plane in a side view.

The sixth elastic abutting portion 103 is provided at the lower portion of the truck frame 30. For example, the sixth elastic abutting portion 103 may be fixed to the lower portion of the truck frame 30 with a bolt or the like via a bracket (not illustrated). For example, the sixth elastic abutting portion 103 may have a shape parallel to a lower surface of the bracket along the horizontal plane in a side view.

For example, an abutting surface on which the fifth elastic abutting portion 102 and the sixth elastic abutting portion 103 abut is provided in substantially parallel to the horizontal plane. A perpendicular line N3 of the abutting surface is substantially parallel to the vertical direction. The perpendicular line N3 of the abutting surface may be inclined forward by a predetermined angle with respect to the vertical direction. For example, a direction along the perpendicular line N3 of the abutting surface (angle of inclination) is not limited to the above and can be changed in accordance with the design specifications.

In the normal state in which the traveling device 5 stands still on flat ground, the fifth elastic abutting portion 102 and the sixth elastic abutting portion 103 are pressed against each other by the weight of the vehicle body frame 3, the cab 2, and the like and abut on each other. In the normal state, the abutting surface of the elastic abutting portions 102 and 103 is substantially parallel to the horizontal plane. In the normal state, the perpendicular line N3 of the abutting surface of the elastic abutting portions 102 and 103 is substantially parallel to the vertical direction. Upward rotation of the third arm member 100 is restricted by abutment between the fifth elastic abutting portion 102 and the sixth elastic abutting portion 103. Due to the abutment between the fifth elastic abutting portion 102 and the sixth elastic abutting portion 103, a load applied to the third track roller 43 and the fourth track roller 44 is received, and an impact received by the third track roller 43 and the fourth track roller 44 is absorbed.

### Carrier Roller

When referring to FIG. 2, the carrier roller 40 is one of a plurality of traveling wheels provided at a front portion and a rear portion of the truck frame 30 (traveling wheel on the upper side). The carrier roller 40 is provided between the idler 31 and the sprocket 32 and above the truck frame 30. The carrier roller 40 is rotatably supported by a pin 110. In the example of the drawing, one carrier roller 40 is provided. The number of carrier rollers 40 is not limited to the above and can be changed in accordance with the design specifications.

### Crawler Belt

When referring to FIG. 2, the crawler belt 50 is wound around the first track roller 41, the rear end idler 80, the second track roller 42, the plurality of the other track rollers 43 to 48, the idler 31, the sprocket 32, and the carrier roller 40. For example, the crawler belt 50 is formed in an endless shape by connecting a plurality of plate-shaped shoes. The crawler belt 50 includes a plurality of links 51.

### Stopper Portion

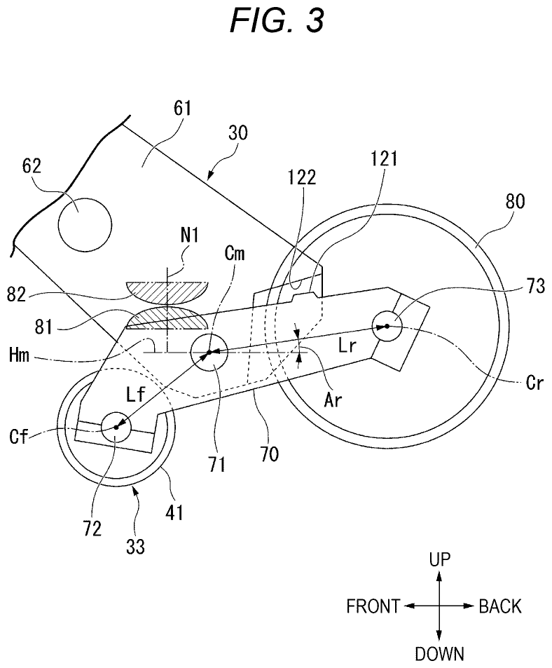

When referring to FIGS. 2 and 3, the traveling device 5 includes stopper portions 121 and 122 provided in the first arm member 70 and the truck frame 30, respectively, between the first arm member 70 and the truck frame 30 in a swinging direction of the rear end portion of the first arm member 70. The stopper portions 121 and 122 abut on each other by the first arm member 70 moving in the direction approaching the truck frame 30 (specifically, rotating counterclockwise about the center-side pin 71).

The stopper portions 121 and 122 include a first-arm-member-side protrusion portion 121 provided on the first arm member 70 and a truck-frame-side receiving portion 122 provided on the truck frame 30. The first-arm-member-side protrusion portion 121 protrudes upward from an upper surface of a rear portion of the first arm member 70. The truck-frame-side receiving portion 122 corresponds to an upper surface portion of a recessed portion formed to be recessed upward from a rear-side lower portion of the rear end frame 61 constituting the truck frame 30. The upper surface portion faces downward. The truck-frame-side receiving portion 122 stops swinging of the first arm member 70 by coming into contact with the first-arm-member-side protrusion portion 121 when the first arm member 70 swings such that the rear end portion of the first arm member 70 is displaced upward.

In the normal state in which the traveling device 5 stands still on flat ground, the first-arm-member-side protrusion portion 121 and the truck-frame-side receiving portion 122 are separated from each other. For example, when the first arm member 70 rotates about 5 degrees to 10 degrees about the center-side pin 71 such that the rear end portion of the first arm member 70 is displaced upward, the first-arm-member-side protrusion portion 121 abuts on the truck-frame-side receiving portion 122. Rotation of the first arm member 70 (specifically, an upward swing of the rear end portion of the first arm member 70) is restricted by the abutment between the first-arm-member-side protrusion portion 121 and the truck-frame-side receiving portion 122. Due to the abutment between the first-arm-member-side protrusion portion 121 and the truck-frame-side receiving portion 122, a load applied to the rear end idler 80 is received, and an impact received by the rear end idler 80 is absorbed.

The stopper portions 121 and 122 may further include a pad made from an elastic material (hereinafter, also referred to as “first elastic pad”) between the first-arm-member-side protrusion portion 121 and the truck-frame-side receiving portion 122. For example, the first elastic pad may be provided on both the first-arm-member-side protrusion portion 121 and the truck-frame-side receiving portion 122. For example, the installation mode of the first elastic pad can be changed in accordance with the design specifications.

### Operation of Structure According to Embodiment

First, a structure according to an embodiment will be described.

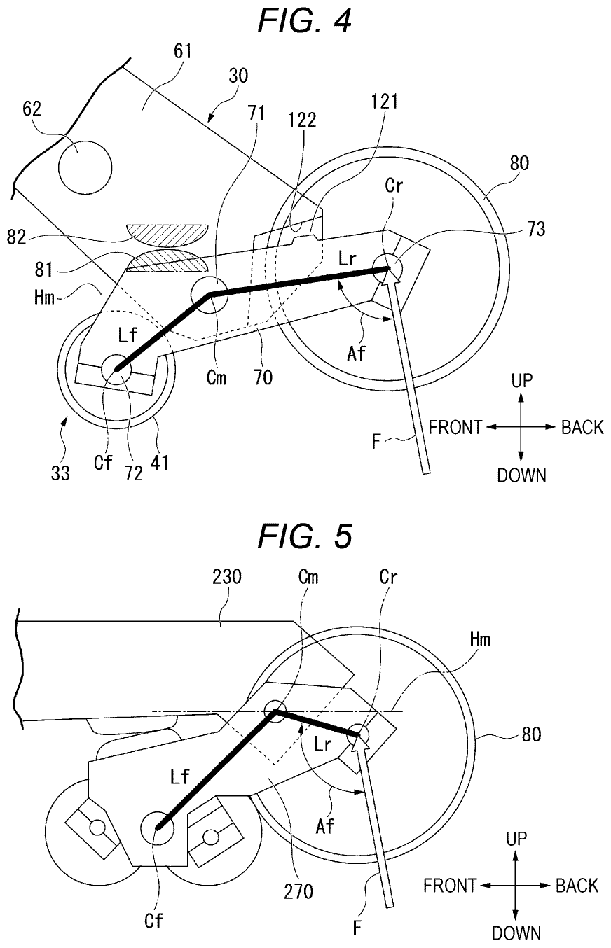

When referring to FIG. 4, the structure according to the embodiment has a single bogie at a front portion of the first arm member 70.

In a side view, the rear-side center-to-center distance Lr between the swing center Cm of the first arm member 70 and the rotation center Cr of the rear end idler 80 is longer than the front-side center-to-center distance Lf between the swing center Cm of the first arm member 70 and the rotation center Cf of the first track roller 41 (Lr>Lf). In the example of the drawing, the rear-side center-to-center distance Lr is about twice the front-side center-to-center distance Lf.

In the normal state in which the traveling device 5 stands still on flat ground, the rotation center Cr of the rear end idler 80 is arranged above the swing center Cm of the first arm member 70. In the example of the drawing, the rotation center Cr of the rear end idler 80 is at a position rotated counterclockwise about the swing center Cm by about 15 degrees with respect to the imaginary horizontal line Hm passing through the swing center Cm of the first arm member 70

Next, a structure according to a comparative example will be described.

When referring to FIG. 5, the structure according to the comparative example has a double bogie at a front portion of a first arm member 270.

In a side view, the rear-side center-to-center distance Lr between the swing center Cm of the first arm member 270 and the rotation center Cr of the rear end idler 80 is shorter than the front-side center-to-center distance Lf between the swing center Cm of the first arm member 270 and the rotation center Cf of the double bogie (Lr<Lf). In the example of the drawing, the rear-side center-to-center distance Lr is about half the front-side center-to-center distance Lf.

In the normal state in which the traveling device 5 stands still on flat ground, the rotation center Cr of the rear end idler 80 is arranged below the swing center Cm of the first arm member 270. In the example of the drawing, the rotation center Cr of the rear end idler 80 is at a position rotated clockwise about the swing center Cm by about 10 degrees with respect to the imaginary horizontal line Hm passing through the swing center Cm of the first arm member 270.

### Difference in Function and Effect from Comparative Example

For example, when the vehicle goes over a large chunk at the time of traveling backward on a bad road, the thrust-up force is generated in the forward and upward direction (arrow F direction in the drawing) in the rear end idler 80 at the rear end portion of the first arm member. In this case, an impact load on the rear end idler 80 is generated in a direction rotated counterclockwise by about 15 degrees from the vertical line.

In the structure of the comparative example in FIG. 5, an angle Af formed by the thrust-up force direction F toward the rear end idler 80 and a line connecting the swing center Cm of the first arm member 270 and the rotation center Cr of the rear end idler 80 is an obtuse angle. In the structure of the comparative example, the torque in an opposite direction around the pin caused by the force applied to the rear end idler 80 tends to be larger than the torque caused by the thrust-up force. Therefore, the translational thrust-up motion is hardly converted into the rotational motion of the first arm member 270, and the impact is hardly released.

Meanwhile, in the structure according to the embodiment of FIG. 4, the angle Af formed by the thrust-up force direction F toward the rear end idler 80 and the line connecting the swing center Cm of the first arm member 70 and the rotation center Cr of the rear end idler 80 is a substantially right angle. In the structure according to the embodiment, when the force acting on the rear end idler 80, for example, the thrust-up force acts, the rotational motion of the first arm member 70 is easily performed. Therefore, the translational thrust-up motion is easily converted into the rotational motion of the first arm member 70, and the impact is easily released. That is, the first arm member 70 converts the thrust-up force of the force in the translation direction acting on the rear end idler 80 into the force in the rotation direction. Therefore, a translational component of the force transmitted from the pin 71 to the truck frame 30 is eliminated, and thus the force transmitted to the vehicle body frame 3 immediately after collision is eliminated. Note that the “translation direction” refers to a direction in which a virtual line extends when the virtual line is assumed to pass through the rotation center Cr of the rear end idler 80 and not to pass through the swing center Cm of the first arm member 70 in a side view. The “translation direction” may be a direction diagonally forward and upward from the rotation center Cr of the rear end idler 80 in a side view.

When the first arm member 70 rotates, the first track roller 41 and the rear end idler 80 attached to the end portions of the first arm member 70 come into frictional contact with the links 51 of the crawler belt 50. This has an effect of attenuating the rotational motion of the first arm member 70.

In the embodiment, the rear-side center-to-center distance Lr is about twice the front-side center-to-center distance Lf, and the rotational motion of the first arm member 70 can be easily converted when the thrust-up force is applied to the rear end idler 80. Therefore, vertical displacement and the thrust-up force of the center-side pin 71 can be halved by the balance effect between vertical displacement of the rear end idler 80 and vertical displacement of the first track roller 41.

In the embodiment, the first arm member 70 replaces most of the translational force applied to the rear end idler 80 in a swinging direction of left rotation of the first arm member 70 with a rotational component of the first arm member 70 and swings through about 5 degrees to 10 degrees. This makes it possible to provide a first-stage impact absorbing mechanism. When a further force is applied to the rear end idler 80 after the first-arm-member-side protrusion portion 121 abuts on the truck-frame-side receiving portion 122, the truck frame 30 rotates counterclockwise about the pivot shaft 62 integrally with the first single bogie device 33. This makes it possible to provide a second-stage impact absorbing structure that further absorbs the impact force.

In the structure of the comparative example of FIG. 5, the rear-side center-to-center distance Lr is shorter than that in the embodiment, and the stroke capable of absorbing the impact is short, and thus the impact is hardly released. The acceleration (load) of the thrust-up force transmitted to the truck frame 30 of the embodiment is smaller than that of the comparative example due to the difference in the structure. For example, the acceleration (load) of the thrust-up force transmitted to the truck frame 30 of the present embodiment is smaller by about 20 percent than that of the comparative example due to the difference in the structure.

In the structure of the comparative example of FIG. 5, the resonance frequency of the spring mass system is far from the representative vibration frequency at the time of traveling, and there is almost no dynamic damper effect at the time of traveling on a flat road or at the time of land leveling work.

Meanwhile, in the structure according to the embodiment of FIG. 4, the resonance frequency determined from the spring constant of the elastic abutting portions 81 and 82 and the rotary inertia about the pin 71 is adjusted to the frequency of pitching and bouncing which are representative vibrations at the time of traveling. Thus, it is possible to exert the dynamic damper effect that is not provided by the comparative example. In the embodiment, the above dynamic damper can suppress the level of vibration (pitching and bouncing vibration of the vehicle body) at the time of traveling on a flat road or at the time of land leveling work, as compared with the comparative example. For example, the level of vibration can be suppressed to about ¼ in the present embodiment. Therefore, ride comfort and land leveling performance can be significantly improved.

### Operation and Effect

As described above, the traveling device 5 for the tracked vehicle 1 according to the present embodiment includes: the truck frame 30 arranged on the side portion of the vehicle body frame 3; the first arm member 70 attached to the truck frame 30 such that the front end portion and the rear end portion are alternately swingable up and down; the first track roller 41 rotatably attached to the front end portion of the first arm member 70; the rear end idler 80 rotatably attached to the rear end portion of the first arm member 70; the plurality of traveling wheels 42 to 48 provided at the front portion and the rear portion of the truck frame 30; and the crawler belt 50 wound around the first track roller 41, the rear end idler 80, and the plurality of traveling wheels 42 to 48. In a side view, the rear-side center-to-center distance Lr between the swing center Cm of the first arm member 70 and the rotation center Cr of the rear end idler 80 is longer than the front-side center-to-center distance Lf between the swing center Cm of the first arm member 70 and the rotation center Cf of the first track roller 41.

For example, when the vehicle goes over a large chunk at the time of traveling backward on a bad road, the thrust-up force is generated in the forward and upward direction in the rear end idler 80 at the rear end portion of the first arm member 70. In a case where the length of the rear-side center-to-center distance Lr is equal to or less than that of the front-side center-to-center distance Lf, the stroke capable of absorbing the impact is short, and thus the impact is hardly released. Meanwhile, according to the present configuration, when the rear-side center-to-center distance Lr is longer than the front-side center-to-center distance Lf, the stroke capable of absorbing the impact is long, and thus the impact is easily released. Therefore, it is possible to reduce the impact at the time of traveling backward on a bad road.

In the present embodiment, the rear-side center-to-center distance Lr is 1.5 times or more and 2.5 times or less the front-side center-to-center distance Lf.

For example, in a case where the rear-side center-to-center distance Lr is less than 1.5 times the front-side center-to-center distance Lf, the stroke capable of absorbing the impact cannot be sufficiently obtained, and thus the impact is hardly released. Meanwhile, in a case where the rear-side center-to-center distance Lr is more than 2.5 times the front-side center-to-center distance Lf, there is a high possibility that an excessive load is applied to the crawler belt 50 and the crawler belt 50 is detached. According to the present configuration, the rear-side center-to-center distance Lr is 1.5 times or more and 2.5 times or less the front-side center-to-center distance Lf, which can suppress occurrence of the above problem. In the present embodiment, the rear-side center-to-center distance Lr is 1.5 times or more and 2.5 times or less the front-side center-to-center distance Lf. However, the present disclosure is not limited to the above, and the rear-side center-to-center distance Lr can be changed in accordance with the design specifications.

In the present embodiment, in the normal state in which the traveling device 5 stands still on flat ground, the rotation center Cr of the rear end idler 80 is arranged above the swing center Cm of the first arm member 70.

For example, when the vehicle goes over a large chunk at the time of traveling backward on a bad road, the thrust-up force is generated in the forward and upward direction in the rear end idler 80 at the rear end portion of the first arm member 70. In this case, an impact load on the rear end idler 80 is generated in a direction rotated counterclockwise by about 15 degrees from the vertical line. In a case where the rotation center Cr of the rear end idler 80 is arranged below the swing center Cm of the first arm member 70 in the normal state in which the traveling device 5 stands still on flat ground, the angle Af formed by the thrust-up force direction toward the rear end idler 80 and the line connecting the swing center Cm of the first arm member 70 and the rotation center Cr of the rear end idler 80 is an obtuse angle. Therefore, the thrust-up force generated in the forward and upward direction in the rear end idler 80 at the rear end portion of the first arm member 70 is hardly converted into the rotational motion, and the impact is hardly released. Meanwhile, according to the present configuration, when the rotation center Cr of the rear end idler 80 is arranged above the swing center Cm of the first arm member 70 in the normal state in which the traveling device 5 stands still on flat ground, the angle Af formed by the thrust-up force direction toward the rear end idler 80 and the line connecting the swing center Cm of the first arm member 70 and the rotation center Cr of the rear end idler 80 is a substantially right angle. Therefore, the thrust-up force generated in the forward and upward direction in the rear end idler 80 at the rear end portion of the first arm member 70 is easily converted into the rotational motion, and the impact is easily released. Therefore, it is possible to more effectively reduce the impact at the time of traveling backward on a bad road.

In the present embodiment, the traveling device 5 for the tracked vehicle 1 further includes the elastic abutting portions 81 and 82 capable of elastically abutting on the other and provided on at least one of the truck frame 30 and the first arm member 70 between the first arm member 70 and the truck frame 30 in the swinging direction of the front end portion of the first arm member 70.

According to this configuration, the impact can be absorbed between the first arm member 70 and the truck frame 30 in the swinging direction of the front end portion of the first arm member 70 by the elastic abutting portions 81 and 82.

In the present embodiment, the elastic abutting portions 81 and 82 are pads made from an elastic material provided on the truck frame 30 and the first arm member 70, respectively.

According to this configuration, the impact can be efficiently absorbed and reduced by both the pads made from the elastic material provided in the truck frame 30 and the first arm member 70, respectively.

The tracked vehicle 1 of the present embodiment includes the cab 2, the vehicle body frame 3 on which the cab 2 is placed, and the traveling device 5 for the tracked vehicle 1.

According to this configuration, it is possible to reduce the impact at the time of traveling backward on a bad road by providing the traveling device 5 for the tracked vehicle 1. This makes it possible to improve the ride comfort of the tracked vehicle 1.

For example, the conventional device does not include the rear end idler 80 and includes the sprocket 32 connected to the main frame at that position. Therefore, in the conventional device, the thrust-up translational force generated when the vehicle goes over a large chunk at the time of traveling backward on a bad road is directly transmitted from the sprocket 32 to the main frame. In the conventional device, a load on the main frame may increase, and the ride comfort may deteriorate.

Meanwhile, in the present embodiment, most of the thrust-up translational force is converted into the torque about the pin 71 by the rotation of the first arm member 70. Therefore, the thrust-up translational force transmitted to the truck frame 30 is significantly reduced. This makes it possible to improve the ride comfort of the tracked vehicle 1.

In addition, in the present embodiment, when the first-arm-member-side protrusion portion 121 comes into contact with the truck-frame-side receiving portion 122, the thrust-up force is transmitted to the main frame via the pivot shaft 62. In the present embodiment, in addition to a long transmission path to the driver's seat, the two-stage impact absorbing structure can reduce the thrust-up force to half or less of that of the conventional device.

For example, in the present embodiment, the resonance frequency determined from the moment of inertia about the pin 71 of the first arm member 70, the first track roller 41, and the rear end idler 80 and the spring constant of the first elastic abutting portion 81 and the second elastic abutting portion 82 is set to the link pitch frequency determined from the vehicle speed at which land leveling work is performed. This makes it possible to configure a dynamic damper device that significantly reduces vibration.

For example, in the present embodiment, the resonance frequency determined from the moment of inertia about the center-side pin 71 of the first arm member 70, the first track roller 41, the front-end-side pin 72, the rear-end-side pin 73, and the rear end idler 80 and the spring constant of the first elastic abutting portion 81 and the second elastic abutting portion 82 is set close to the link pitch frequency determined from the vehicle speed at which land leveling work is performed. This makes it possible to configure a dynamic damper device that significantly reduces vibration and to significantly reduce pitching vibration and bouncing vibration of the vehicle.

### Modifications

The above embodiment shows an example where the rear-side center-to-center distance is 1.5 times or more and 2.5 times or less the front-side center-to-center distance, but the present disclosure is not limited thereto. For example, the rear-side center-to-center distance may be less than 1.5 times the front-side center-to-center distance. For example, the rear-side center-to-center distance may be more than 2.5 times the front-side center-to-center distance. For example, the rear-side center-to-center distance may be longer than the front-side center-to-center distance. For example, the magnification of the rear-side center-to-center distance with respect to the front-side center-to-center distance can be changed in accordance with the design specifications.

The above embodiment shows an example where, in the normal state in which the traveling device stands still on flat ground, the rotation center of the rear end idler is arranged above the swing center of the first arm member. However, the present disclosure is not limited thereto. For example, in the normal state in which the traveling device stands still on flat ground, the rotation center of the rear end idler may be arranged at a height equal to or less than the swing center of the first arm member. For example, the arrangement mode of the rotation center of the rear end idler can be changed in accordance with the design specifications.

The above embodiment shows an example where the stopper portion includes the first-arm-member-side protrusion portion provided on the first arm member and the truck-frame-side receiving portion provided on the truck frame and configured to stop swinging of the first arm member by coming into contact with the first-arm-member-side protrusion portion when the first arm member swings such that the rear end portion of the first arm member is displaced upward. However, the present disclosure is not limited thereto. For example, the stopper portion may include a truck-frame-side protrusion portion provided on the truck frame and a first-arm-member-side receiving portion provided on the first arm member and configured to stop swinging of the first arm member by coming into contact with the truck-frame-side protrusion portion when the first arm member swings such that the rear end portion of the first arm member is displaced upward. For example, the configuration mode of the stopper portions (the mode of the protrusion portion and the receiving portion) can be changed in accordance with the design specifications.

The above embodiment shows an example where the traveling device for the tracked vehicle further includes the elastic abutting portion capable of elastically abutting on the other and provided on at least one of the truck frame and the first arm member between the first arm member and the truck frame in the swinging direction of the front end portion of the first arm member. However, the present disclosure is not limited thereto. For example, the traveling device for the tracked vehicle may or may not include the elastic abutting portion. For example, the installation mode of the elastic abutting portion can be changed in accordance with the design specifications.

The above embodiment shows an example where the elastic abutting portions are elastic pads made from an elastic material provided on the truck frame and the first arm member, respectively. However, the present disclosure is not limited thereto. For example, the pads made from an elastic material may be provided on one of the truck frame and the first arm member and may or may not be provided on the other. For example, the installation mode of the pads made from an elastic material can be changed in accordance with the design specifications.

The tracked vehicle of the above embodiment includes the cab, the vehicle body frame on which the cab is placed, and the traveling device for the tracked vehicle as an example. However, the present disclosure is not limited thereto. For example, the tracked vehicle may or may not include the cab in which the driver rides. For example, the tracked vehicle may be a manned tracked vehicle that is driven on the basis of a driving operation by a driver or may be an unmanned tracked vehicle that is driven in an unmanned manner without a driving operation by a driver. For example, the installation mode of the cab can be changed in accordance with the design specifications.

The above embodiment shows an example where the tracked vehicle is a bulldozer. However, the present disclosure is not limited thereto. For example, the tracked vehicle may be another work vehicle such as a crawler dump, an excavator, or a tractor. For example, the mode of the tracked vehicle can be changed in accordance with the design specifications.

Although the embodiments of the present disclosure have been described above, the present disclosure is not limited thereto, and addition, omission, substitution, and other changes of configurations can be made without departing from the gist of the present disclosure, and the above embodiments can be appropriately combined.

### Supplementary Note 1

A traveling device for a tracked vehicle, the traveling device including:
a truck frame arranged on a side portion of a vehicle body frame;
a first arm member attached to the truck frame such that a front end portion and a rear end portion are alternately swingable up and down;
a first track roller rotatably attached to the front end portion of the first arm member;
a rear end idler rotatably attached to the rear end portion of the first arm member;
a plurality of traveling wheels provided at a front portion and a rear portion of the truck frame; and
a crawler belt wound around the first track roller, the rear end idler, and the plurality of traveling wheels, in which
a rear-side center-to-center distance between a swing center of the first arm member and a rotation center of the rear end idler is longer than a front-side center-to-center distance between the swing center of the first arm member and a rotation center of the first track roller in a side view.

### Supplementary Note 2

The traveling device for a tracked vehicle according to supplementary note 1, in which
the first arm member converts a force in a translation direction acting on the rear end idler into a force in a rotation direction.

### Supplementary Note 3

The traveling device for a tracked vehicle according to supplementary note 1 or 2, in which
an angle formed by a direction of a force acting on the rear end idler and a line connecting the swing center of the first arm member and the rotation center of the rear end idler in a side view is a right angle.

### Supplementary Note 4

The traveling device for a tracked vehicle according to any one of supplementary notes 1 to 3, in which
the rear-side center-to-center distance is 1.5 times or more and 2.5 times or less the front-side center-to-center distance.

### Supplementary Note 5

The traveling device for a tracked vehicle according to any one of supplementary notes 1 to 4, in which
in a normal state in which the traveling device stands still on flat ground, the rotation center of the rear end idler is arranged above the swing center of the first arm member.

### Supplementary Note 6

The traveling device for a tracked vehicle according to any one of supplementary notes 1 to 5, further including
a stopper portion that restricts rotation of the first arm member in a case where the rear end portion of the first arm member swings upward.

### Supplementary Note 7

The traveling device for a tracked vehicle according to supplementary note 6, in which
the stopper portion includes
a first-arm-member-side protrusion portion provided on the first arm member, and
a truck-frame-side receiving portion provided on the truck frame and configured to stop swinging of the first arm member by coming into contact with the first-arm-member-side protrusion portion when the first arm member swings such that the rear end portion of the first arm member is displaced upward.

### Supplementary Note 8

The traveling device for a tracked vehicle according to supplementary note 7, in which
when a further force is applied to the rear end idler after the first-arm-member-side protrusion portion abuts on the truck-frame-side receiving portion, the truck frame rotates integrally with the first arm member.

### Supplementary Note 9

The traveling device for a tracked vehicle according to any one of supplementary notes 1 to 8, further including
an elastic abutting portion capable of elastically abutting on the other and provided on at least one of the truck frame or the first arm member between the first arm member and the truck frame in a swinging direction of the front end portion of the first arm member.

### Supplementary Note 10

The traveling device for a tracked vehicle according to supplementary note 9, in which
the elastic abutting portion is a pad made from an elastic material provided in the truck frame and the first arm member.

### Supplementary Note 11

A tracked vehicle including:
a cab;
the vehicle body frame on which the cab is placed; and
the traveling device for a tracked vehicle according to any one of supplementary notes 1 to 10.

### REFERENCE SIGNS LIST

1 Tracked vehicle
2 Cab
3 Vehicle body frame
5 Traveling device
30 Truck frame
40 Carrier roller (traveling wheel)
41 First track roller
42 to 48 Track roller (traveling wheel)
50 Crawler belt
60 Frame body
61 Rear end frame
70 First arm member
80 Rear end idler
81 First elastic abutting portion
82 Second elastic abutting portion
121 First-arm-member-side protrusion portion (stopper portion)
122 Truck-frame-side receiving portion (stopper portion)
Af Angle formed by direction of force acting on rear end idler and line connecting swing center of first arm member and rotation center of rear end idler in side view
Cm Rotation center of center-side pin (swing center of first arm member)
Cf Rotation center of first track roller
Cr Rotation center of rear end idler
Lf Front-side center-to-center distance
Lr Rear-side center-to-center distance

1. A traveling device for a tracked vehicle, the traveling device comprising:
a truck frame arranged on a side portion of a vehicle body frame;
a first arm member attached to the truck frame such that a front end portion and a rear end portion are alternately swingable up and down;
a first track roller rotatably attached to the front end portion of the first arm member;
a rear end idler rotatably attached to the rear end portion of the first arm member;
a plurality of traveling wheels provided at a front portion and a rear portion of the truck frame; and
a crawler belt wound around the first track roller, the rear end idler, and the plurality of traveling wheels, wherein
a rear-side center-to-center distance between a swing center of the first arm member and a rotation center of the rear end idler is longer than a front-side center-to-center distance between the swing center of the first arm member and a rotation center of the first track roller in a side view.

2. The traveling device for a tracked vehicle according to claim 1, wherein
the first arm member converts a force in a translation direction acting on the rear end idler into a force in a rotation direction.

3. The traveling device for a tracked vehicle according to claim 1, wherein
an angle formed by a direction of a force acting on the rear end idler and a line connecting the swing center of the first arm member and the rotation center of the rear end idler in a side view is a right angle.

4. The traveling device for a tracked vehicle according to claim 1, wherein
the rear-side center-to-center distance is 1.5 times or more and 2.5 times or less the front-side center-to-center distance.

5. The traveling device for a tracked vehicle according to claim 1, wherein
in a normal state in which the traveling device stands still on flat ground, the rotation center of the rear end idler is arranged above the swing center of the first arm member.

6. The traveling device for a tracked vehicle according to claim 1, further comprising
a stopper portion that restricts rotation of the first arm member in a case where the rear end portion of the first arm member swings upward.

7. The traveling device for a tracked vehicle according to claim 6, wherein
the stopper portion includes
a first-arm-member-side protrusion portion provided on the first arm member, and
a truck-frame-side receiving portion provided on the truck frame and configured to stop swinging of the first arm member by coming into contact with the first-arm-member-side protrusion portion when the first arm member swings such that the rear end portion of the first arm member is displaced upward.

8. The traveling device for a tracked vehicle according to claim 7, wherein
when a further force is applied to the rear end idler after the first-arm-member-side protrusion portion abuts on the truck-frame-side receiving portion, the truck frame rotates integrally with the first arm member.

9. The traveling device for a tracked vehicle according to claim 1, further comprising
an elastic abutting portion capable of elastically abutting on the other and provided on at least one of the truck frame or the first arm member between the first arm member and the truck frame in a swinging direction of the front end portion of the first arm member.

10. The traveling device for a tracked vehicle according to claim 9, wherein
the elastic abutting portion is a pad made from an elastic material provided in the truck frame and the first arm member.

11. A tracked vehicle comprising:
a cab;
the vehicle body frame on which the cab is placed; and
the traveling device for a tracked vehicle according to claim 1.

12. The traveling device for a tracked vehicle according to claim 2, wherein
an angle formed by a direction of a force acting on the rear end idler and a line connecting the swing center of the first arm member and the rotation center of the rear end idler in a side view is a right angle.

13. The traveling device for a tracked vehicle according to claim 2, wherein
the rear-side center-to-center distance is 1.5 times or more and 2.5 times or less the front-side center-to-center distance.

14. The traveling device for a tracked vehicle according to claim 2, wherein
in a normal state in which the traveling device stands still on flat ground, the rotation center of the rear end idler is arranged above the swing center of the first arm member.

15. The traveling device for a tracked vehicle according to claim 2, further comprising
a stopper portion that restricts rotation of the first arm member in a case where the rear end portion of the first arm member swings upward.

16. The traveling device for a tracked vehicle according to claim 15, wherein
the stopper portion includes
a first-arm-member-side protrusion portion provided on the first arm member, and
a truck-frame-side receiving portion provided on the truck frame and configured to stop swinging of the first arm member by coming into contact with the first-arm-member-side protrusion portion when the first arm member swings such that the rear end portion of the first arm member is displaced upward.

17. The traveling device for a tracked vehicle according to claim 16, wherein
when a further force is applied to the rear end idler after the first-arm-member-side protrusion portion abuts on the truck-frame-side receiving portion, the truck frame rotates integrally with the first arm member.

18. The traveling device for a tracked vehicle according to claim 2, further comprising
an elastic abutting portion capable of elastically abutting on the other and provided on at least one of the truck frame or the first arm member between the first arm member and the truck frame in a swinging direction of the front end portion of the first arm member.

19. The traveling device for a tracked vehicle according to claim 18, wherein
the elastic abutting portion is a pad made from an elastic material provided in the truck frame and the first arm member.

20. A tracked vehicle comprising:
a cab;
the vehicle body frame on which the cab is placed; and
the traveling device for a tracked vehicle according to claim 2.
